(19) United States
(12) Patent Application Publication
(10) Pub. No.: US 2015/0004384 A1
(43) Pub. Date: Jan. 1, 2015

(54) Insulation apparatus and method

(71) Applicant: John W. Mallette, Pensacolo, FL (US)

(72) Inventor: John W. Mallette, Pensacolo, FL (US)

(21) Appl. No.: 14/121,339

(22) Filed: Aug. 21, 2014

Related U.S. Application Data
(63) Continuation-in-part of application No. 13/694,297, filed on Nov. 16, 2012, now Pat. No. 8,840,987.
(60) Provisional application No. 61/294,432, filed on Jan. 12, 2010.

(51) Int. Cl. B32B 15/14; B32B 15/20; G10K 11/162; B32B 7/02; B32B 5/02; B32B 27/06; B32B 7/08; B32B 5/18

(52) U.S. Cl. CPC B32B 15/14; B32B 7/08; B32B 15/20; B32B 5/18; B32B 7/02; B32B 5/028; B32B 5/024; B32B 27/065; G10K 11/162; B32B 2311/24; B32B 2250/05; B32B 2255/02; B32B 2307/102; B32B 2307/304; B32B 2307/3065
USPC 428/215; 428/219; 428/220; 428/319.1; 428/457; 442/1; 442/218; 442/233

(57) ABSTRACT

A layered insulation apparatus and method of making that contains a multiple layer insulation that has top and bottom outside moisture barrier layers, with at least two flame retardant layer around a center metal layer. The metal layer may be two metal sheets with a scrim there-between. The metal layer is highly polished to reflect heat. The metal layer is protected from heat by the flame retardant layers and protected from moisture by the outside moisture barrier layers. A sound abatement layer may optionally be layered on top of the first moisture barrier layer.

This application is a Continuation In Part of U.S. Ser. No. 13/694,297, filed on Nov. 16, 2012, which claims priority of U.S. Provisional Application Ser. No. 61/294,432, filed on Nov. 18, 2011, incorporated herein by reference

### BACKGROUND OF THE INVENTION

1. Field of the Invention

This invention relates to an improved insulation apparatus and method. In particular, in accordance with one embodiment, the invention relates to an improved insulation apparatus consisting of a top moisture barrier outside layer. This layer is followed by a flame retardant layer, then a metal layer, then another flame retardant layer and, finally, a bottom moisture barrier outside layer.

2. Brief Description of Related Art

Insulating and sound deadening composites are well known in the art and in particular to the recreational vehicle, boating, automobile and aviation industries, for example only. In general, machinery produces sound and heat. It is often useful and necessary to deaden as much of the sound and heat as possible. Typically, these insulating and sound deadening composites are generally composed of combinations of textile fabrics, insulating battings, and, sometimes impervious vapor barrier films. These films come in various forms including metalized films made by vapor deposition of a metal, such as Aluminum, to provide a reflective surface.

Again, such insulating and sound deadening composites are found in use with aircraft, luxury RV's, yachts, automobiles and/or racing vehicles of all types. Properly installed, these prior composites address some of the problems but often not all of them in one system and usually not for the life of the vehicle. One problem with prior art insulation products is that they are required to pass minimal FAA burn test requirements but the products that pass this test provide only minimal protection. Additionally, normal insulation in use today requires four to ten inches of space behind interior panels. The insulation normally used consists of Mylar bags filled with fiberglass batt insulation material. This material is subject to breaking down and failing. In aircraft, for example, over time the accumulation of multiple ascents and descents causes the fiberglass batt material to break down. When this occurs, if a workman accidently ruptures the bag, penetrating the bag with a tool, the fiberglass is released into the air system of the aircraft, subjecting the crew and occupants to exposure to carcinogenic particles and the aircraft owners to potential lawsuits.

A further drawback to the composites known in the art relates to their relatively ineffective and space using systems for sound deadening. A further drawback to the known composites relates to their relative ineffectiveness and the amount of space required by sound deadening products. These systems are not yet required to pass any FAA certifications, automobile or boat/yachting regulations or standards. In order to accomplish any significant sound reduction effects are large, heavy and expensive.

The current invention is an insulation that provides effective flame retardation that exceeds existing government standards. It also provides moisture prevention and sound attenuation. It is also lightweight and does not require a lot of space as it has a low profile height. The current invention does not degrade during normal use and is relatively inexpensive to construct compared to existing products.

It is therefore, an object of the invention to provide a flame, extreme heat reflecting and moisture resistant system that also provides superior sound insulation that meets or greatly exceeds existing government standards. It is further an object to provide a flame, extreme heat reflecting and moisture resistant system that reflects heat. It is a further object to provide a flame, extreme heat reflecting and moisture resistant material composition that is relatively inexpensive, lightweight and compact. It is further an object of the invention to provide an extreme heat reflecting and moisture resistant material composition that is “green” in that it does not produce outgassing because there is no fiberglass, is battery acid proof, blue water proof and does not degrade during normal use

Other objects, features and advantages of the present invention will become apparent from the following detailed description of the preferred embodiment and the accompanying drawings.

### SUMMARY OF THE INVENTION

A layered insulation apparatus and method of making that contains a multiple layer insulation apparatus that has a top layer moisture barrier outside layer, followed by a first flame retardant layer, followed by a metal layer, followed by a second flame retardant layer, and finally followed by a bottom moisture barrier outside layer. A sound abatement layer may optionally be layered on top of the first moisture barrier layer.

### BRIEF DESCRIPTION OF THE FIGURES

FIG. 1 is a cross sectional view of the insulation showing the multiple layers according to a first embodiment;

FIG. 2 is a cross sectional view of the insulation showing the multiple layers according to a second embodiment;

FIG. 3 is a Cone calorimeter Thermal Response test of the thermal apparatus of the invention; and

FIG. 4 is a Modified Bunker Gear Test of the Insulated Apparatus of the invention.

FIG. 5 is a cross sectional view of the insulation showing the multiple layers according to a third embodiment of the invention.

### DETAILED DESCRIPTION

### Definitions

All terms used herein are given their common meaning as known to those of ordinary skill in the art.

The term “moisture barrier” is any material that creates a moisture block or barrier. Moisture barrier means that 100% of the moisture is prevented from passing through the material. The moisture barrier protects the metal layer from moisture degradation. Suitable moisture barriers include plastics and cellular foam materials that are now known or hereafter developed. The moisture barrier also protects the insulation from absorbing water or other fuels.

The term “flame retardant” describes material that is fire proof at least at some temperatures and for some length of time when exposed to flame or heat.

The term “sound abatement” is used in a common manner to describe a material that absorbs or deadens sound.

The term “reflectivity” or “heat reflection” describes the property of the material to reflect heat rather than absorb heat.

The term “cotton gauze” means a woven cotton gauze similar to medical gauze that is a loose weave with low density, lightweight and airy.

Suitable mesh size include but are not limited to:

30×20 19×15 20×12 11×8,
30*20, 28*24, 26*18, 19*15, 20*12
32×28, 30×28, 30×20, 28×24, 20×12, 19×15, 11×

Suitable yarn size includes but is not limited to: 21's 32's 40's

Suitable thickness ply includes but is not limited to: 1-16 ply

The term “ASTM” stands for the American Society for Testing and Materials. ASTM is an international standards organization that develops and publishes voluntary consensus technical standards for a wide range of materials, products, systems, and services.

The term “NFPA” stands National Fire Protection Association which is a United States trade association (albeit with some international members) that creates and maintains private, copyrighted, standards and codes for usage and adoption by local governments.

### First Embodiment

In a first embodiment of the invention the insulation material is made by layering a top outside moisture barrier layer, followed by a flame retardant layer, followed by a metal layer, followed by another flame retardant layer and then by a bottom outside moisture barrier layer. A sound abatement layer may optionally be layered on top of and connected to the top outside moisture barrier layer. The sound abatement layer is closed cell foam.

In this first embodiment, the top outside moisture barrier layer is a plastic flame resistant, non-residue film. The flame retardant layer is a cloth layer. The cloth can be one hundred percent (100%) cotton or cotton muslin or cotton gauze. It is preferred that the cotton or cotton muslin is formed in a waffle weave pattern but a thin gauze similar to medical grade gauze is also very desirable. The metal layer is preferably aluminum. The aluminum is approximately ninety-nine percent industrial grade aluminum and is highly polished. The bottom moisture barrier outside layer is flame resistant, non-residue film.

### Second Embodiment

According to a second embodiment of the invention, an improved multi-layered insulation is made of a top outside moisture barrier layer. This is followed by a flame retardant cloth layer, then an aluminum metal layer, then a spacer (polyester scrim), then another aluminum metal layer, then another flame retardant cloth layer and, finally, a bottom outside moisture barrier layer. A sound abatement layer can optionally be connected with the top outside moisture barrier layer of the first, second and third embodiments. It should be noted that a laminate of two aluminum layers with the spacer layer there-between can be presented as a single layer rather than three individual layers.

In this second embodiment, the sound abatement layer is foam, fiberglass, thermo-acoustic material, rubber or wool. The cloth is one hundred percent cotton/cotton muslin gauze or waffle weave pattern or cotton gauze. The spacer is a polyester scrim. The metal layer is highly polished aluminum of a ninety-nine percent pure industrial grade. The bottom moisture barrier outside layer is flame resistant, non-residue film.

### Third Embodiment

In a third embodiment of the invention, an improved multi-layered insulation is made of a top outside moisture barrier layer. This is followed by a flame retardant cloth layer, then an aluminum metal layer, then a spacer (polyester scrim), then another aluminum metal layer, then another flame retardant cloth layer, then an aluminum metal layer, then a spacer layer, then another aluminum metal layer, then a flame retardant cloth layer, then finally, a bottom outside moisture barrier layer. A sound abatement layer can optionally be connected with the top outside moisture barrier layer.

When the insulation is made with no sound abatement layer, there is no fiberglass in the layering materials. The invention is a “green” product. It uses layered natural fabric, fibers, metals and laminates. There are no detectable VOC/SVOC's, and no carcinogenic materials. This means that there is no “outgassing” when the insulation is subjected to extreme heat, i.e. any temperature in excess of 1218 F or 659 C (melting point of aluminum.

The benefits of the invention are that when it is used in an aircraft or other enclosure, it reflects heat away from the cabin or other enclosure. Less bleed air is needed for comfort levels. It protects sensitive avionics and equipment. It reduces fuel consumption and allows additional time to evacuate personnel in an emergency.

Heat Reflecting and Insulating Capabilities:

The insulation of the invention reflects up to 98% radiant heat away from the fuselage, reflects up to 90% conductive heat back into the cabin or enclosure, reflects up to 90% interior convective/conductive heat, reflects radiant/conductive heat from interior of aircraft or enclosure when parked; reflects radiant heat away from sensitive cockpit. equipment. The insulation of the invention insulates interior from extreme cold at cruise altitude and can be used to insulate interior floor of aircraft.

The insulation of the invention, all embodiments, has been tested and exceeds 60 minute burn test using 3400 degrees F. torch from either direction.

This is accomplished because the insulation reflects heat in both directions due to the highly polished aluminum metal layer.

Moisture Proof Capabilities:

The insulation of the invention is moisture proof, battery acid proof, blue water proof (salt water), and waterproof. The insulation does not degrade during normal use because no moisture reaches the highly polished aluminum. Hence, the aluminum remains highly polished with no blemishes, clouding or other deterioration that would diminish reflectivity.

FAA Burn Test Requirements:

The insulation of the invention exceeds FAA burn test requirements

Thickness Profile:

The insulation of the first embodiment of the invention is as follows: (without spacer)
Flame retardant layer of gauze: about 1/16 inch plus or minus 1/32 inch.
Flame retardant layer of cotton waffle weave: about ⅛ inch plus or minus 1/32 inch.
   The insulation of the second embodiment of the invention is as follows: (with spacer)
Flame retardant layer of gauze: about 1/16 inch plus or minus 1/32 inch.
Flame retardant layer of cotton waffle weave: about ⅛ inch plus or minus about 1/32 inch.
   The insulation of the third embodiment of the invention is as follows: (with multiple spacers.
Flame retardant layer of gauze: about 2/16 inch plus or minus about 1/32 inch.
Flame retardant layer of cotton waffle weave: about ¼ inch plus or minus about 1/32 inch.

Sample Weight Profiles of Individual Layers:

Moisture Barrier layer: about 1.05 oz./square yard

Waffle Cloth: about 7.04 oz/square yard

Gauze Cloth: about 3.31 oz/square yard

Metal/spacer/metal laminate (3 layers together): about 1.96 oz/square yard

Sample Weight Profiles of Various Embodiments:

1st and 2nd Embodiments with waffle weave: about 17.5-18.4 oz/square yard

1^{st} and 2^{nd} Embodiments with gauze: about 10-11 oz/square yard

3rd Embodiment with waffle weave: about 28-28.2 oz/square yard

3^{rd} Embodiment with gauze: about 15.8-16 oz/square yard

### Methods of Making:

The invention also relates to a method of making an improved insulation according to the first embodiment of the invention. The steps of making include:

layering a top outside moisture barrier layer, then a first flame retardant layer, then a metal layer, then a second flame retardant layer then a bottom outside moisture barrier layer. The method can include an additional step of layering a sound abatement layer over the top outside moisture barrier layer.

The invention also relates to a method of making an improved insulation according to the second embodiment of the invention. The steps of making include:

Layering a top outside moisture barrier layer, then a first flame retardant layer, then a first metal layer, then a spacer, then a second metal layer, then a second flame retardant layer, then a bottom outside moisture barrier layer. This method can include an additional step of layering a sound abatement layer over the top outside moisture barrier layer.

The invention also relates to a method of making an improved insulation according to the third embodiment of the invention. The steps of making include: Layering a top outside moisture barrier layer, then a flame retardant cloth layer, then an aluminum metal layer, then a spacer (polyester scrim), then another aluminum metal layer, then another flame retardant cloth layer, then an aluminum metal layer, then a spacer layer, then another aluminum metal layer, then a flame retardant cloth layer, then finally, a bottom outside moisture barrier layer. A sound abatement layer can optionally be connected with the top outside moisture barrier layer.

Now turning to the figures.

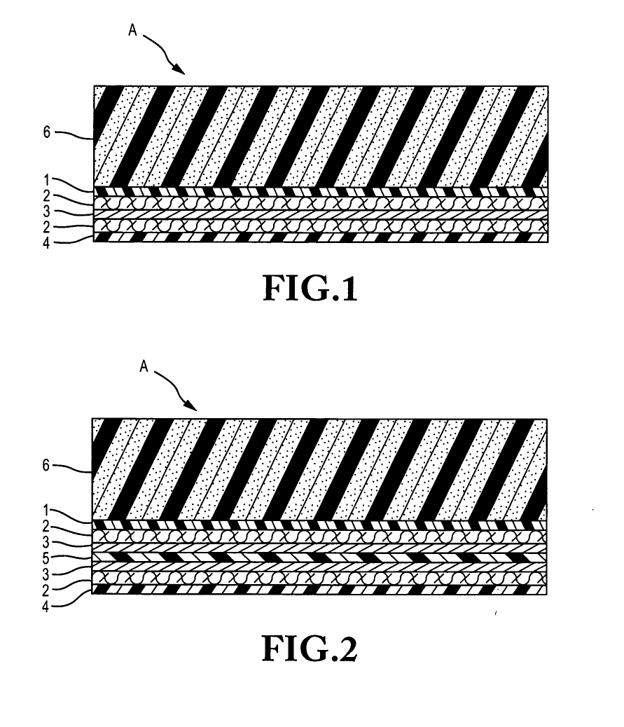

FIG. 1 is a cross-sectional view of the first embodiment of the invention. As shown, the insulation A includes a top outside moisture barrier layer. This is followed by a flame retardant layer 2, then a metal layer 3, then another flame retardant layer 2 and finally a bottom outside moisture barrier layer 4. Optionally, a sound abatement layer 6 is connected with the top outside moisture barrier layer 1. This simplified embodiment is found to function extremely well and is even thinner and lighter weight than the second embodiment. However, the second embodiment with the extra layering is more suitable for harsher and more rigorous environments.

FIG. 2 is a cross-sectional view of the preferred second embodiment of the invention. As shown, the insulation A includes a top outside moisture barrier layer. This is followed by a flame retardant layer 2, then a metal layer 3, then a spacer layer 5, then another metal layer 3, then another flame retardant layer 2 and finally a bottom outside moisture barrier layer 4. Optionally, a sound abatement layer 6 is connected with the top outside moisture barrier layer 1.

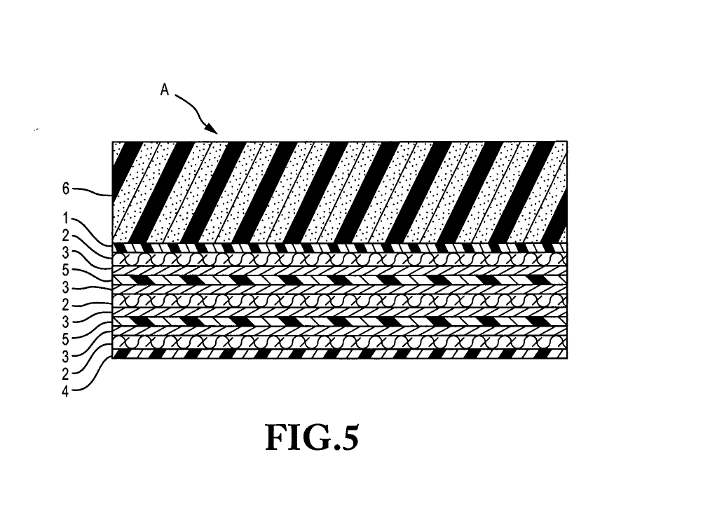

FIG. 5 is a cross sectional view of the third embodiment of the invention. As shown, the insulation A includes a top outside moisture barrier layer 1. This is followed by a flame retardant cloth layer 2, then an aluminum metal layer 3, then a spacer (polyester scrim) 5, then another aluminum metal layer 3, then another flame retardant cloth layer 2, then an aluminum metal layer 3, then a spacer layer 5, then another aluminum metal layer 3, then a flame retardant cloth layer 2, then finally, a bottom outside moisture barrier layer 4. A sound abatement layer 6 can optionally be connected with the top outside moisture barrier layer.

Moisture barrier layer: While any suitable material useful for the stated purposes of the invention may be used, Applicant has determined that the layered insulation A achieves the best results when the top outside moisture barrier layer, and, also preferably, bottom moisture barrier outside layer 4 are three (3) mil clear, non-static, flame resistant, moisture proof, non-residue film, such as APTIV PEEK® (pressure sensitive) film Victrex Polymer Solutions, Succasunna, N.J. It is preferable that the moisture barrier layer has the property of having a high heat performance that can withstand lead free high heat reflection from soldering temperatures. The moisture barrier layer is applied so that the inside of the insulation is 100% moisture protected. The moisture barrier layer is preferably heat sealed on the outside of the layers to prevent moisture entry.

Flame retardant layer: Applicant has determined by testing that the layered insulation of the invention functions well when the flame retardant layer 2 is one hundred percent cotton muslin in a “waffle “weave”, as that term is known in the industry, coated with a flame proof coating. One type of suitable flameproof coating is Fire'Z-OFF® manufactured by RDR Technologies LLC, Oklahoma City, Okla. It is preferred that the flame proof coating be acceptable in accordance with NFPA 255, with a Class A rating. Another type of flame retardant layer is cotton gauze having a weigh of about 3.31 oz/square yard. This gauze is similar to medical gauze. The flame retardant layer is positioned on both sides of the aluminum to protect the aluminum from flame damage in either direction.

Metal layer: Applicant has determined that the most effective insulation apparatus A, is created when the metal layer 3 is ninety-nine percent pure industrial grade, class A, class I fire certified, highly polished, paper thin aluminum sheets. The metal layer reflects up to 95% radiant heat. It keeps heat or cold from penetrating or leaving an insulted space.

Spacer: The spacer layer 5 is most effective in the form of a polyester scrim that creates airspace between the two metal layers 3, when that configuration is presented. The Polyester Scrim is a standard production layer in the double-side aluminum. It is as thin as a piece of copy paper, about 4 mil. The purpose of the spacer layer is to add an air space between the aluminum layers.

Sound Abatement: Sound abatement layer 6 may be any sound abatement material. One example of a sound abatement layer is melamine closed cell foam. Other sound abatement materials may also be used, such as thermo-acoustic material, rubber, various leathers, balsa wood & wools. A four-inch layer of sound abatement is very effective when extra soundproofing is required. The thickness of the sound abatement layer may be adjusted to meet the particular insulation sound abatement application. The sound abatement layer operates by absorbing sound.

Stitching: Stitching of all layers together except the moisture barrier layer is preferred. Cotton thread is used for stitching through the layers. A running stitch is used in a straight line. The space between the lines is generally about ½-2 inches apart. After the stitching is completed, the moisture barrier layer is applied to the front and back of the insulation.

Results of Testing:

It has been shown that this combination of materials in this layered formation provides an extraordinarily effective insulation apparatus. Testing shows the invention to have passed the FAA FAR “Burn Test” in all its many parts and sections. For example, The FAA “burn test” requires a fifteen second vertical burn using a Bunsen burner with no continuous burning flame after five seconds. The present insulation, in all embodiments, lasted over nine minutes without a burn through and extinguished itself immediately when the flame was removed.

Still further, the FAA test requires a fifteen second vertical burn using a Bunsen burner with no continuous flame after five seconds. The invention met and exceeded this test.

In another test, the invention reflected heat, from the sun, for example, from the inside of an aircraft upwards of ninety-eight percent (98%). The invention reflects ambient (convective/conductive) temperatures back inside the aircraft upwards of ninety percent (90%). The invention repels moisture above and below flooring and it contains no fiberglass, carcinogenic materials or vapor deposition aluminum.

The insulation of the invention passes VOC (Volatile Organic Compounds) and SVOC (Semi-Volatile Organic Compounds) testing with virtually no contaminates detected. Further, the present invention passed the Skydrol (Jet Fuel), battery acid and blue water (urine) testing in which it was submerged for two weeks in each and did not absorb any of the fluids or, in other words, it did not absorb any of the fluids. It is preferred that the first embodiment of the insulation be about 1.4 oz per square foot and the insulation of the second embodiment be about 2.4 oz per square foot.

The layers can be held together on their edges or can be held together by other means such as gravity, friction other suitable means. The layers can be attached by simply laying the layers one on top of the other. A quilting process of 1″ 2″ or 3″ widths can also hold the layers together. Machine quilting is accomplished using an industrial quilting machine utilizing multiple needles that sews (using various threads) across the width and/or length of the layers. It is preferred that the quilting of the layers together is through the fire retardant layers, metal layer(s) and spacer layer, and not through the moisture barrier layer. As such, the moisture barrier layer is applied as a layer after the quilting process. The moisture barrier films such as APTIV PEEK film (self-adhesive film) also holds the fabrics together.

### Method of Insulating an Apparatus:

The invention also relates to a method of insulating an apparatus or vehicle. The steps of insulating include:

providing an insulation material as described above; and installing the insulation material in the apparatus or vehicle.

The insulation and method of the invention provide an all in one insulation, flame retardant, moisture retardant and sound abatement insulation apparatus. It is easy to cut with scissors or a straight blade. It installs easily. Hook and loop connections can be used for connecting edges of the insulation to a substrate (such as a vehicle or plane interior space) and it folds easily which allows it to be easily shipped and then custom fit into the desired spaces.

### EXAMPLES

### Example 1

### Vertical Flammability Results of the Second Embodiment of the Invention

14 CFR 25.856 (c) Appendix F Part 6 vertical 12 second burn test:

Average self extinguish time may not exceed 15 seconds

Average burn length may not exceed 8″

Average dripping may not exceed 5 seconds after failing

Material Description: Second embodiment

| | Flame time | Self Extinguish | Burn length | Drippings |
|---|---|---|---|---|
| Sample | (Seconds) | (seconds) | (inches) | (seconds) |
| #1 | 12 | 0 | 2.2 | 0 |
| #2 | 12 | 0 | 2.1 | 0 |
| #3 | 12 | 0 | 1.8 | 0 |
| Average | 12.0 | 0.00 | 2.03 | 0.00 |

The insulation in this test passed the vertical flammability test.

### Example 2

### Flame Propagation Results

### 14 CFR 25.856 (c) Appendix F Part 6

Flame propagation must not exceed 2″

Self-extinguish time must not exceed 3 seconds on any sample

Material Description:

Conditioning 70 degrees+/−5, Humidity 50%+−10%, calorimeter 1.51, Thermocouple 498 degrees

| | Length × width | Flame time | Self | Flame |
|---|---|---|---|---|
| Sample | (inches) | (seconds) | extinguish | propagation |
| #1 | 23 × 12½ | 15 | 3 | 1.4 |
| #2 | 23 × 12½ | 15 | 2 | 1.2 |
| #3 | 23 × 12½ | 15 | 2 | 1.1 |
| Average | | 15.00 | 2.33 | 1.23 |

The insulation in this test passed the flame propagation test.

### Example 3

### Testing of the First Embodiment of the Invention

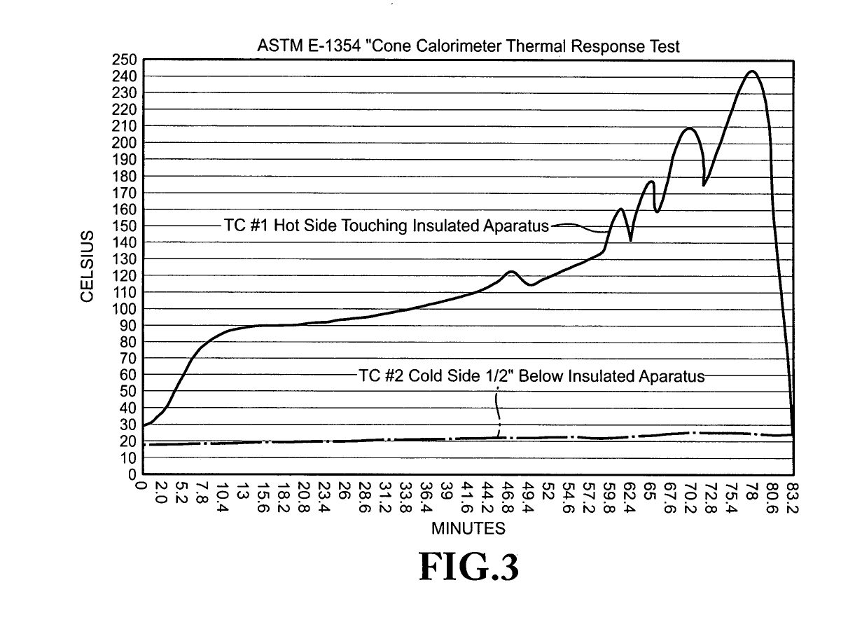

The insulation of the invention was subjected to a Cone calorimeter Thermal Response Test as described in ASTM E-1354. The results are shown in FIG. 3. It is seen that the insulation prevented the heat from penetrating through the insulation even at temperatures of about 245 degrees Celsius.

### Example 4

### Testing of the First Embodiment of the Invention

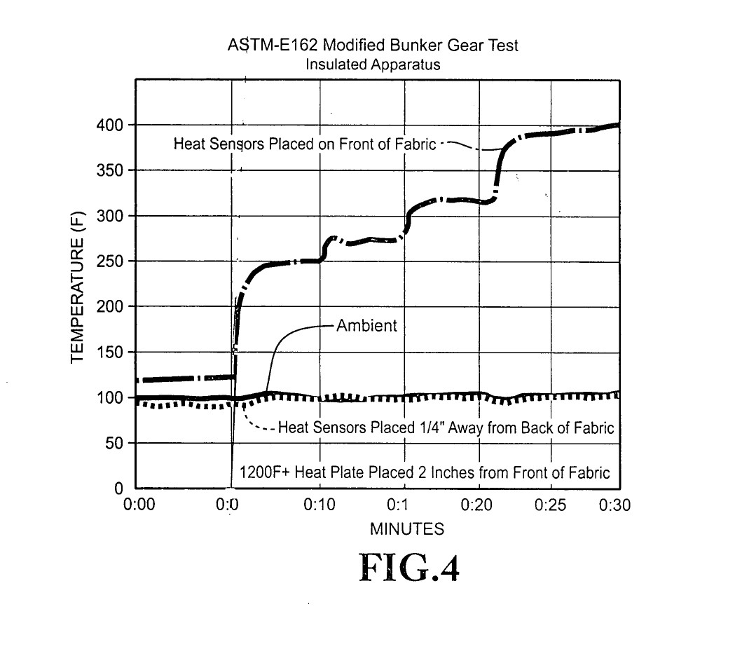

The insulation of the invention was subjected to a Modified Bunker Gear Test as described in ASTM-E162. The results are shown in FIG. 4. It is shown from the results that the insulation prevented the heat from penetrating through the insulation even at temperatures of about >400 degrees Fahrenheit.

Applications:

The insulation of the present invention has many applications including but not limited to aircraft, spacecraft, automobiles, homes, appliances, and recreational vehicles.

The description of the present embodiments of the invention has been presented for purposes of illustration, but is not intended to be exhaustive or to limit the invention to the form disclosed. Many modifications and variations will be apparent to those of ordinary skill in the art. As such, while the present invention has been disclosed in connection with an embodiment thereof, it should be understood that other embodiments may fall within the spirit and scope of the invention as described and set forth herein.

What is claimed is:

1. A layered insulation apparatus comprising:
a) a top outside moisture barrier layer followed by;
b) a first flame retardant layer followed by;
c) a highly polished reflective aluminum metal layer followed by;
d) a spacer layer followed by;
e) a second polished reflective aluminum metal layer followed by;
f) a second flame retardant layer; and followed by
g) a bottom outside moisture barrier layer, with the proviso that there is no fiberglass or glue used.

2. The layered insulation of claim 1, wherein each of the first and second flame retardant layers are cloth with a flame proof coating.

3. The layered insulation of claim 2 wherein the cloth is cotton muslin waffle weave cloth with a flame proof coating or cotton gauze with a flame proof coating.

4. The layered insulation of claim 1, wherein said insulation is about 1/16 to ⅛ inch thick.

5. The layered insulation apparatus of claim 1, further comprising a sound abatement layer.

6. The layered insulation apparatus of claim 5, wherein said sound abatement layer is on top of said top outside moisture barrier layer or said bottom outside moisture barrier layer.

7. The layered insulation apparatus of claim 1, wherein said top outside moisture barrier layer and said bottom outside moisture barrier layer are flame resistant plastic or flame resistant cellular foam.

8. The layered insulation apparatus of claim 1, wherein said top outside moisture barrier layer and said bottom outside moisture barrier layer are 3 millimeter, clear, non-static flame resistant moisture proof non-residue film.

9. The layered insulation apparatus of claim 1, wherein said spacer layer comprises polyester scrim.

10. The layered insulation apparatus of claim 1, wherein the inside of the insulation is 100% moisture protected from water, salt water and fuel.

11. The layered insulation apparatus of claim 1, wherein said aluminum metal layer is 99% industrial grade, class A, class I fire certified, highly polished aluminum sheet.

12. The apparatus of claim 1, wherein the first and second flame retardant layers, first and second metal layers and scrim are stitched together.

13. The apparatus of claim 1, wherein the weight of the insulation is about 10-18.4 oz/square yard.

14. The apparatus of claim 1, wherein the insulation has the property that it produces no outgassing when subjected to extreme heat of about 1218 degrees Fahrenheit.

15. The apparatus of claim 1, wherein the insulation reflects up to 98% radiant heat away and reflects up to 90% conductive heat away.

16. The apparatus of claim 1, wherein the insulation has the property that it exceeds 60 minute burn test using 3400 degrees F. torch from either front or back directions.

17. The apparatus of claim 1, wherein the first metal layer, the scrim and the second metal layer are a single unit between the first and second flame retardant layers.

18. The apparatus of claim 1, wherein the insulation reflects up to 98% radiant heat away and reflects up to 90% conductive heat away.

19. A layered insulation apparatus comprising:
a) a top outside moisture barrier layer followed by;
b) a first flame retardant layer followed by;
c) a first polished aluminum metal layer followed by;
d) a first spacer layer followed by;
e) a second polished aluminum metal layer followed by;
f) a second flame retardant layer;
g) a third polished aluminum metal layer followed by
h) a second spacer layer followed by
i) a fourth polished aluminum metal layer followed by
j) a third flame retardant layer followed by
g) a bottom outside moisture barrier layer, with the proviso that there is no fiberglass or glue used.

20. The layered insulation of claim 19, wherein each of the first and second flame retardant layers are cloth with a flame proof coating.

21. The layered insulation of claim 20, wherein the cloth is cotton muslin waffle weave cloth with a flame proof coating or cotton gauze with a flame proof coating.

22. The layered insulation of claim 19, wherein said insulation is about ⅛ to ¼ inch thick.

23. The layered insulation apparatus of claim 19, further comprising a sound abatement layer.

24. The layered insulation apparatus of claim 23, wherein said sound abatement layer is on top of said top outside moisture barrier layer or said bottom outside moisture barrier layer.

25. The layered insulation apparatus of claim 19, wherein said top outside moisture barrier layer and said bottom outside moisture barrier layer are flame resistant plastic or flame resistant cellular foam.

26. The layered insulation apparatus of claim 19, wherein said top outside moisture barrier layer and said bottom outside moisture barrier layer are 3 millimeter, clear, non-static flame resistant moisture proof non-residue film.

27. The layered insulation apparatus of claim 19, wherein said spacer layer comprises polyester scrim.

28. The layered insulation apparatus of claim 19, wherein the inside of the insulation is 100% moisture protected from water, salt water and fuel.

29. The layered insulation apparatus of claim 19, wherein said aluminum metal layer is 99% industrial grade, class A, class I fire certified, highly polished aluminum sheet.

30. The apparatus of claim 19, wherein the flame retardant layers, metal layers and scrim are stitched together.

31. The apparatus of claim 19, wherein the weight of the insulation is about 15.8 to 28.2 oz/square yard.

32. The apparatus of claim 19, wherein the insulation has the property that it produces no outgassing when subjected to extreme heat.

33. The apparatus of claim 19, wherein the insulation reflects up to 98% radiant heat away and reflects up to 90% conductive heat away.

34. The apparatus of claim 19, wherein the insulation has the property that it exceeds 60 minute burn test using 3400 degrees F. torch from either direction.
